(19) United States
(12) Patent Application Publication
(10) Pub. No.: US 2022/0035355 A1
(43) Pub. Date: Feb. 3, 2022

(54) MEASUREMENT VALUE PROCESSING SYSTEM AND MEASUREMENT VALUE PROCESSING METHOD

(71) Applicant: Endress+Hauser Conducta GmbH+Co. KG, Gerlingen (DE)

(72) Inventors: Stefan Robl, Hünxe (DE); Bo Ottersten, Regensburg (DE); Carsten Schmidt, Marburg (DE)

(21) Appl. No.: 17/392,853

(22) Filed: Aug. 3, 2021

(30) Foreign Application Priority Data
Aug. 3, 2020 (DE) 10 2020 120 456.6

(51) Int. Cl. G05B 23/02; G06F 16/20

(52) U.S. Cl. CPC G05B 23/02; G06F 16/20

(57) ABSTRACT

The present disclosure relates to an electronic unit having a sensor connection for receiving at least one measurement value from a sensor, a first data memory, a first communication module, a first display unit and a first input unit, wherein the first data memory has a file with at least one measurement value name and allows for saving the measurement value, wherein the first display unit allows for displaying the measurement value name of the file and of the measurement value, wherein the first input unit allows for assigning the measurement value name to the measurement value.

### CROSS-REFERENCE TO RELATED APPLICATION

The present application is related to and claims the priority benefit of German Patent Application No. 10 2020 120 456.6, filed on Aug. 3, 2020, the entire contents of which are incorporated herein by reference.

### TECHNICAL FIELD

The present disclosure relates to a measurement value processing system and a measurement value processing method.

### BACKGROUND

In analytical measurement technology, such as in the fields of water management, environmental analysis and in industry, for example in food technology, biotechnology and pharmaceuticals, as well as for various laboratory applications, measurands, such as the pH value, the conductivity or the concentration of analytes, such as ions or dissolved gases in a gaseous or liquid measurement medium, are of great importance. These measurands can be recognized and/or monitored, for example, by means of electrochemical sensors, such as optical, potentiometric, amperometric, voltammetric or coulometric sensors, or even conductivity sensors.

A sensor is usually operated together with a transmitter at a point of measurement. The transmitter may be designed as a portable device. In this case, the transmitter together with the sensor is used at different points of measurement. The transmitter is suitable for reading out the raw data or signals of the sensor and converting them into measurement values of a specific measured variable, and for storing and/or transmitting them to a superordinate system, such as a control center or PC/server. For subsequent processing of the measurement values, for example if a user wants to analyze a measurement value development at all points of measurement, it is advantageous if the measurement values have a unique designation or name that is specific to the point of measurement. This makes it possible, for example, for the user not to confuse different lines of measurement with one another. Until now, users had to manually carry out the measurement values of the sensor which were determined at a specific point of measurement by entering a designation of the measurement values at the transmitter. However, the transmitters usually used normally have only rudimentary input possibilities, so that entering a name designation of the measurement values is complicated and time-consuming.

### SUMMARY

It is therefore an object of the present disclosure to propose a device and a method which allow for simple and error-free naming of measurement values.

This object is achieved according to the present disclosure by an electronic unit according to claim 1.

The electronic unit according to the present disclosure comprises a sensor connection for receiving at least one measurement value from a sensor, a first data memory, a first communication module, a first display unit, and a first input unit. The first data memory has a file with at least one measurement value name and is suitable for enabling storing of the measurement value. The first display unit is suitable for enabling the displaying of the measurement value name of the file and of the measurement value. The first input unit is suitable for enabling an assignment of the measurement value name to the measurement value.

When the measurement values are named by a user, the electronic unit according to the present disclosure makes it possible for the interaction time to be reduced very strongly; ease of use, efficiency and reliability of the measurement value processing can be increased thereby.

According to one embodiment of the present disclosure, the electronic unit further comprises a time unit which provides the current time. The electronic unit is suitable for storing a time at which the measurement value is received and the assignment, made by the user via the first input unit, of the measurement value name to the measurement value as a selection history in the first data memory. When a further measurement value is received, the electronic unit is suitable for suggesting a measurement value name based on the current time and the selection history or automatically assigning it to the further measurement value.

According to one embodiment of the present disclosure, the electronic unit further comprises a positioning unit suitable for generating or receiving measurement value specific positioning data. The electronic unit is suitable for automatically assigning the at least one measurement value name to the at least one measurement value as a function of the measurement value specific positioning data.

According to one embodiment of the present disclosure, the electronic unit is suitable for suggesting a measurement value name or automatically assigning it to the measurement value as a function of a measurement value range to which the received measurement value can be assigned.

This object according to the present disclosure is furthermore achieved by an electronic unit according to claim 5.

The electronic unit according to the present disclosure comprises a sensor connection for receiving at least one measurement value from a sensor, a first data memory, a first communication module, and a positioning unit. The first data memory has a file with at least one measurement value name and allows for storing the measurement value. The positioning unit is suitable for generating or receiving measurement value specific positioning data. The electronic unit is suitable for automatically assigning the at least one measurement value name to the at least one measurement value as a function of the measurement value specific positioning data.

The object according to the present disclosure is also achieved by a measurement value processing system according to claim 6.

The measurement value processing system according to the present disclosure comprises:
an electronic unit according to the present disclosure,
a computation unit with a second communication module and a second input unit. The second input unit enables an input of at least one measurement value name. The second communication module enables the measurement value name to be sent to the electronic unit.

According to one embodiment of the present disclosure, the computer unit comprises a positioning unit suitable for providing measurement value specific positioning data to the computation unit. The computation unit is suitable for transmitting the measurement value specific positioning data to the electronic unit via the second communications module so that the electronic unit is suitable for automatically assigning the at least one measurement value name to the at least one measurement value as a function of the measurement value specific positioning data.

According to one embodiment of the present disclosure, the positioning unit is suitable for interacting with a global positioning system based on GPS, Galileo, GLONASS, BeiDou or with a local positioning system based on Bluetooth beacon, radio beacons, or LIDAR.

The object according to the present disclosure is also achieved by a measurement value processing method according to claim 9.

The measurement value processing method according to the present disclosure comprises the steps of:
providing an electronic unit according to the present disclosure,
connecting the sensor connection of the electronic unit to a sensor,
receiving at least one measurement value from the sensor at the electronic unit,
storing the measurement value in the first data memory,
loading the file with at least one measurement value name from the first data memory,
displaying the measurement value and the at least one measurement value name,
assigning the measurement value name to the measurement value by means of the first input unit.

According to one embodiment of the present disclosure, the electronic unit further comprises a time unit which provides the current time. The electronic unit stores a time at which the measurement value is received and the assignment, made by the user via the first input unit, of the measurement value name to the measurement value as a selection history in the first data memory. When a further measurement value is received, the electronic unit suggests a measurement value name based on the current time and the selection history or automatically assigns the measurement value name to the further measurement value.

According to one embodiment of the present disclosure, the electronic unit further comprises a positioning unit which generates or receives measurement value specific positioning data, wherein the electronic unit suggests or automatically assigns the at least one measurement value name to the at least one measurement value as a function of the measurement value specific positioning data.

According to one embodiment of the present disclosure, the electronic unit suggests a measurement value name using a measurement value range file or automatically assigns the measurement value name to the measurement value as a function of a measurement value range to which the received measurement value can be assigned.

The object according to the present disclosure is also achieved by a measurement value processing method according to claim 13.

The measurement value processing method according to the present disclosure comprises the steps of:
providing an electronic unit according to the present disclosure;
connecting the sensor connection of the electronic unit to a sensor,
receiving at least one measurement value from the sensor at the electronic unit,
storing the measurement value in the first data memory,
generating or receiving measurement value specific positioning data by the positioning unit,
loading the file with at least one measurement value name from the first data memory,
automatically assigning the measurement value name to the measurement value as a function of the measurement value specific positioning data.

The object according to the present disclosure is also achieved by a measurement value processing method according to claim 14.

The measurement value processing method according to the present disclosure comprises the steps of:
providing a measurement value processing system according to the present disclosure,
connecting the sensor connection of the electronic unit to a sensor,
receiving at least one measurement value from the sensor at the electronic unit,
storing the measurement value in the first data memory,
entering at least one measurement value name at the second input unit of the computation unit,
transmitting the measurement value name via the second communication module of the computation unit to the electronic unit,
displaying the measurement value and the at least one measurement value name,
assigning the measurement value name to the measurement value by means of the first input unit.

### BRIEF DESCRIPTION OF THE DRAWINGS

The present disclosure will be explained in more detail on the basis of the following description of the figures.

FIG. 1 shows a schematic representation of a measurement value processing system according to the present disclosure.

FIG. 2 shows a schematic representation of an alternative embodiment of the measurement value processing system from FIG. 1.

FIG. 3 shows a schematic representation of an alternative embodiment of the measurement value processing system in FIG. 2.

FIG. 4 shows a schematic representation of an electronic unit according to the present disclosure with a positioning unit.

FIG. 5 shows a schematic representation of an alternative embodiment of the electronic unit in FIG. 4.

### DETAILED DESCRIPTION

FIG. 1 shows an embodiment of a measurement value processing system 1 according to the present disclosure having an electronic unit 110 and a computation unit 130.

The electronic unit 110 has a sensor connection 111 to which a sensor 120 can be connected. The electronic unit 110 can thus receive at least one measurement value M from the sensor 120. The sensor connection 111 is, for example, an electrical plug connector which makes a sensor 120, that is connected via a cable, connectable to the electronic unit 110. It is also possible for the sensor connection 111 to be a connection unit which allows the sensor 120 to be connected to be directly mechanically latched to the sensor connection 111. An example of this is applicant's Memosens interface, which comprises a mechanical bayonet coupling and an inductive data and power transmission.

The sensor 120 is, for example, a pH sensor, oxygen sensor, chlorine dioxide sensor, or a similar sensor. A measurement value M is understood to be a value measured by the sensor 120, i.e., for example, a measured pH value, oxygen content, chlorine dioxide content, or other parameters of a measurement medium. For the sake of simplicity, the term measurement value M is used below. However, a plurality of measurement values M can of course also be meant instead of the one measurement value M, insofar as this is technically possible.

The electronic unit 110 further comprises a first data memory 112. The first data memory 112 comprises, for example, a memory fixedly installed in the electronic unit 110 or a removable memory card. The first data memory 112 can be designed, for example, as a file system or as a flash memory. The first data memory 112 is suitable for storing a date, i.e., a piece of information, in a defined storage region of the data memory 112. When reference is made below to “file,” “measurement value range file,” or “position file,” such term is to be understood not only in connection with a file system but also as a piece of information stored at a predetermined memory address in the data memory 112 or contained in the data memory 112.

The electronic unit 110 further comprises a first communication module 113 for transmitting and/or receiving data. For example, the first communication module 113 is suitable for sending the measurement value M to the computation unit 130 and/or for receiving a measurement value name MB from the computation unit 130. The first communication module 113 comprises, for example, a Bluetooth module, a WLAN module or another wireless communication module.

The electronic unit 110 further comprises a first display unit 114. The first display unit 114 allows for displaying, for example, the measurement value name MB, a list of measurement value names MB, or the measurement value M. The first display unit 114 comprises, for example, an LCD display or a similar display.

The electronic unit 110 further comprises a first input unit 115. The first input unit 115 allows for selecting, for example, a measurement value name MB and assigning the selected measurement value name MB to a measurement value M or a series of measurement values M. The first input unit 115 comprises, for example, one or more pushbuttons and/or rotary knobs.

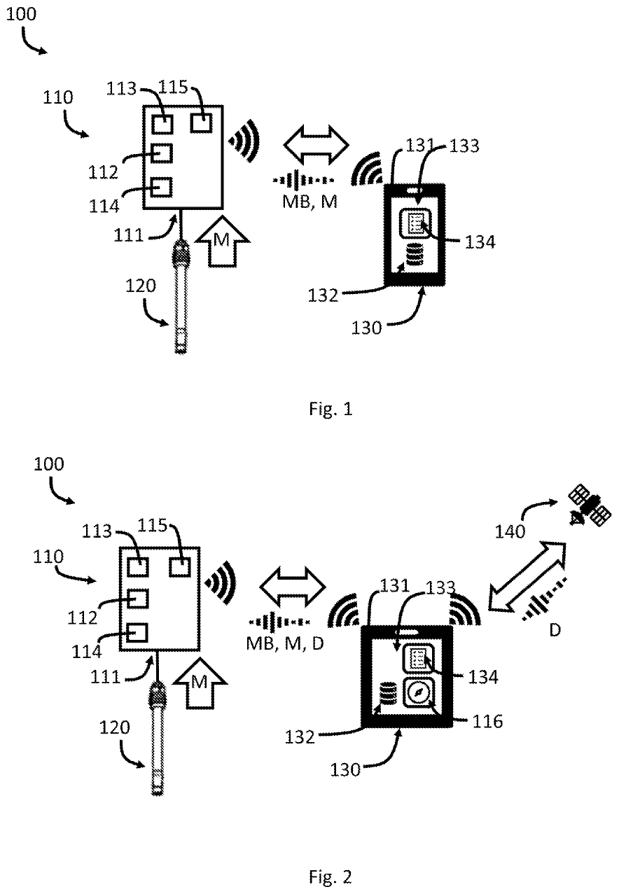

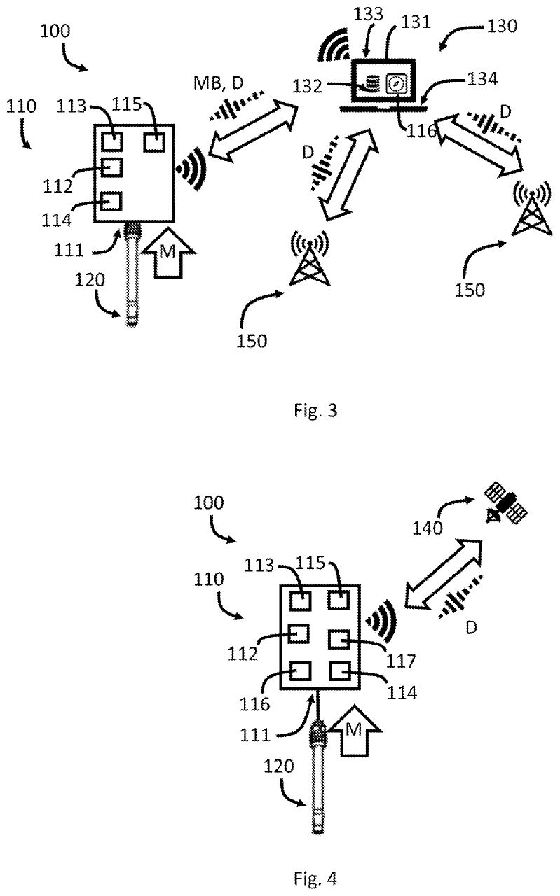

The computation unit 130 comprises, for example, a smartphone, a tablet (see FIG. 1 or FIG. 2), a laptop, PC/Mac (see FIG. 3) or another smart system suitable for communicating with the first communication module 113. The computation unit 130 comprises a second communication module 131, a second data memory 132, a second display unit 133 and a second input unit 134.

The second communication module 131 is preferably identical in function to the first communication module 113 or is at least suitable for communicating with the first communication module 113.

The second input unit 134 is suitable for enabling an alphanumeric input of a measurement value name MB. The second input unit 134 comprises, for example, a keyboard or a tactile screen or touchscreen. If the second input unit 134 is a touchscreen, the second display unit 133 will naturally also simultaneously be the second input unit 134. The second input unit 134 is suitable for a user to enter a measurement value name MB in order to provide it to the electronic unit 110 via the second communication module 131.

The second display unit 133 allows for displaying the entered measurement value name MB or an entered list with measurement value names MB. The second display unit 133 is also suitable for displaying measurement values M received from the electronic unit 110.

The second data memory 132 is suitable for storing measurement value names MB and/or measurement value M.

It is thus possible to create a measurement value name MB by means of the computation unit 130 and to send it to the electronic unit 110. The user can then assign the measurement value name MB to the measurement value M at the electronic unit 110. The method for naming the measurement value will be discussed below.

FIG. 2 and FIG. 3 each show an embodiment of the measurement value processing system 1 that is complementary to the embodiment described above. Here, the computation unit 130 additionally comprises a positioning unit 116. The positioning unit 116 is suitable for interacting with a global positioning system 140 (see FIG. 2) based on GPS, Galileo, GLONASS, BeiDou or with a local positioning system 15 (see FIG. 3) based on Bluetooth beacon, radio beacons, or LIDAR in order to generate or receive measurement value specific positioning data D. Measurement value specific positioning data D means geographical coordinates or other geographical information

In the case of a local positioning system 140, static position information can be emitted, i.e., transmitted for example by a radio beacon. Depending on the signal strength of the signal emitted by the local positioning system 140, the positioning unit 116 can then identify the distance at which the local positioning system 140 is positioned relative to the positioning unit 116. The positioning unit 116 comprises either a piece of information saying where the local positioning system 140 is positioned, or such piece of information is transmitted from the local positioning system 140 to the positioning unit 116 via the static position information. In the case of a plurality of radio beacons, the positioning unit 116 can thus calculate, i.e., generate, very precisely its own position relative to the radio beacons. If the positioning unit 116 receives signals from three radio beacons, three-dimensional positioning is possible for the positioning unit 116. If a beacon in a closed space, which comprises a point of measurement, has measurement value specific positioning data D specific to this point of measurement can be generated for the positioning unit 116, for example.

The computation unit 130 is furthermore suitable for providing the electronic unit 110 with the measurement value specific positioning data D via the the second communication module 131. The electronic unit 110 is thus enabled to automatically assign, or suggest for assignment, a measurement value name MB to the measurement value M as a function of the measurement value specific positioning data D.

Of course, the electronic unit 110 can also have a positioning unit 116 which is suitable for interacting with a global positioning system 140 and with a local positioning system 15.

If the electronic unit 110 contains several measurement value names MB, for example in the form of a list, the electronic unit 110 is suitable for arranging the list with measurement value names MB as a function of the measurement value specific positioning data D. In this case, the first data memory 112 of the electronic unit 110 has a position file where one position is stored for each measurement value name MB stored in the list. The electronic unit 110 is suitable for comparing the respective positions of the measurement value names MB with the measurement value specific positioning data D, and for automatically assigning the measurement value name MB, which to the position that best correlates with the measurement value specific positioning data D, to the measurement value M.

Instead of an automatic assignment, the electronic unit 110 can also suggest a measurement value name MB as a function of the measurement value specific positioning data D so that the user only has to confirm the assignment of the measurement value name MB to the measurement value M via the first input unit 115.

This makes it possible for the user to assign a specific measurement value name to the measurement value M with as little effort as possible, or to specifically name the data sets of the measurement value M.

FIG. 4 shows an embodiment that is compatible with the above-described embodiments in which the electronic unit 110 includes a time unit 117. The time unit 117 is, for example, a clock or other device for measuring time. The time unit 117 is suitable for providing the current time, i.e., the current date and/or time. The time unit 117 enables the electronic unit 110 to store the time of receipt for each measurement value M received. The electronic unit 110 is also suitable for creating a selection history for the measurement values M. This means that a table is created with the received measurement values M, the associated times of receipt and the respectively selected measurement value name MB. The electronic unit 110 is thus suitable for suggesting a measurement value name MB based on the current time and the selection history when a further measurement value M is received from the sensor 120.

As shown in FIG. 4, no computation unit 130 is necessary in this embodiment for inputting a measurement value name MB. In this embodiment, the first data memory 112 comprises a file with at least one measurement value name MB. By means of the positioning unit 116 described above, the electronic unit 110 is suitable for automatically carrying out an assignment of the measurement value name MB to the measurement value M or for suggesting it for assignment. The file is, for example, stored in the first data memory 112 already ex factory. The measurement value names MB stored in the file include, for example, a functionally meaningful term. Examples are: “Fresh water inlet,” “Clarification basin 1,” “Clarification basin 1 Outlet,” etc.

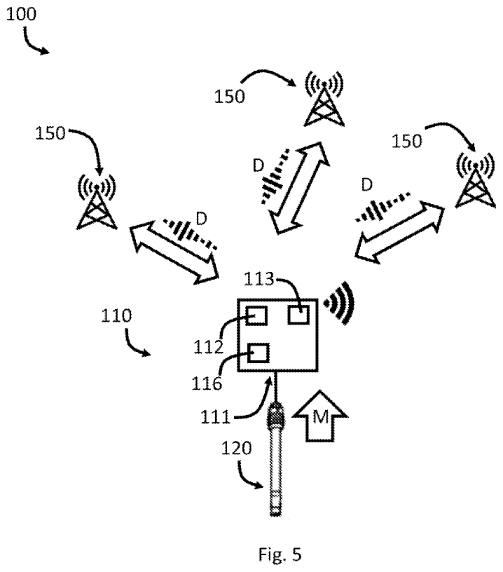

As shown in FIG. 5, neither a first display unit 114 nor a first input unit 115 are necessary in this embodiment since the measurement value name MB from the file stored in the first data memory 112 can be loaded with measurement value names MB, and the assignment of the measurement value name MB to the measurement value M takes place automatically by means of the positioning unit 116. Of course, a first display unit 114 and a first input unit 115 could be present to check the automatic assignment.

In all embodiments described above, the electronic unit 110 is advantageously suitable for suggesting a measurement value name MB to the user for selection, depending on a measurement value range to which the received measurement value M can be assigned, or automatically assigning the measurement value name MB to the measurement value M. The first data memory 112 has a measurement value range file in which different measurement value ranges are listed in a form linked to different measurement value names MB. It is thus possible for the electronic unit 110 to compare the measurement value M with the measurement value ranges of the measurement value range file and to, for example, automatically assign the measurement value name MB, which is linked to the applicable measurement value range, to the measurement value M. The measurement value range file can also link further information to the various measurement value names MB, for example a temperature range. In this case, the measurement value M comprises a plurality of sub-measurement values, such as pH and temperature of the measurement medium. In order for a measurement value name MB to be assigned to a measurement value M in this case, the measurement value M must be within a predetermined pH measuring range and temperature range.

The measurement value processing method according to the present disclosure is discussed in detail below.

According to a first embodiment, which is hereinafter referred to as “manual method,” the measurement value processing system 100 described above is provided in a first implicit step. “Providing” here means that the measurement value processing system 100 is ready for use.

As can be seen in FIG. 1, a sensor 120 is then connected to the electronic unit 110 via the sensor connection 111, and at least one measurement value M is received from the sensor 120. The measurement value M is then stored in the first data memory 112 of the electronic unit 110.

In a next step, a measurement value name MB or a plurality of measurement value names MB are created by an input from the user by means of the second input unit 134 at the computation unit 130, i.e. manually entered, for example. To check the input, the user can have the measurement value name MB displayed by means of the second display unit 133 and, if necessary, and can correct it by means of the second input unit 134.

The entered measurement value name MB or measurement value names MB is then transmitted by the second communication module 131 from the computation unit 130 to the first communication module 113 of the electronic unit 110. It is also possible to transmit the measurement value M or a plurality of measurement values M from the electronic unit 110 to the computation unit 130.

Next, the measurement value M and the measurement value name MB are displayed on the first display unit 114 of the electronic unit 110. If a plurality of measurement value names MB have been created and transmitted to the electronic unit 110, the measurement value names MB may be displayed on the first display unit 114 in the form of a list. This enables the user to select a suitable measurement value name MB for the measurement value M. The user then assigns a measurement value name MB to the measurement value M by means of the first input unit 115 on the electronic unit 110.

The embodiments illustrated in FIG. 2 and FIG. 3, which are referred to below as “automatic method” or “semi-automatic method,” differ from the manual method described above in that the positioning unit 116 of the computation unit 130 is additionally used: In an additional method step, the positioning unit 116 receives measurement value specific positioning data D from a global positioning system 140 (see FIG. 2) or from a local positioning system 15 (see FIG. 3). The computation unit 130 subsequently transmits the measurement value specific positioning data D to the electronic unit 110.

Thanks to the measurement value specific positioning data D, it is possible to replace the above-described assignment step by an input of the user at the first input unit 115 by means of a semi-automatic or fully automatic assignment of the measurement value name MB to the measurement value M based on the measurement value specific positioning data D. Semi-automatic means that the user has to confirm a measurement value name MB suggested by the electronic unit 110. Fully automatic means that the user no longer has to confirm a suggested measurement value name MB.

An assignment based on the measurement value specific positioning data D requires that the electronic unit 110 has a position file in the first data memory 112. The position file includes various position data and a measurement value name MB associated with the respective position data.

If the electronic unit 110 receives measurement value specific positioning data D from the computation unit 130, the electronic unit 110 compares the received measurement value specific positioning data D with the position data of the position file. The measurement value name MB, which is linked to position data closest to the measurement value specific positioning data D, is then used by the electronic unit 110 to assign the measurement value name MB to the measurement value M.

In an automatic assignment of the measurement value name MB to the measurement value M, the above-described step of inputting a measurement value name MB and transmitting the measurement value name MB to the electronic unit 110, the step of displaying the measurement value M and the measurement value name MB, and the step of assigning the measurement value name MB to the measurement value M by means of the first input unit 115 are no longer necessary. In this fully automatic variant, the user thus gains considerable ease of use.

As an alternative to the automatic assignment based on the measurement value specific positioning data D, the measurement value name MB selected by the electronic unit 110 can also be suggested only to the user in order to achieve a checking of the assignment by the user. Thus, in this semi-automatic variant of the method only the step of entering a measurement value name MB and the step of sending the measurement value name MB to the electronic unit 110 are omitted.

The variant shown in FIG. 4 and FIG. 5 differs from those described above in that the positioning unit 116 is arranged in the electronic unit 110. Thus, no computation unit 130 is necessary. Therefore, as a first implicit step only the electronic unit 110 is provided and a measurement value M is received from the sensor 120 at the electronic unit 110 via the sensor connection 111 and is stored in the first data memory 112. The measurement value M is then assigned a measurement value name MB as a function of the measurement value specific positioning data D.

The above-described step of receiving measurement value specific positioning data D by the positioning unit 116 from a global positioning system 140 (see FIG. 4) or from a local positioning system 15 (see FIG. 5) thus takes place in the electronic unit 110. Of course, the above-described step of transmitting the measurement value specific positioning data D to the electronic unit 110 is thus omitted.

As an alternative to using the positioning unit 116, the electronic unit 110 can have a file in the first data memory 112 in which at least one measurement value name MB is present. In this case, the electronic unit 110 with the file in the first data memory 112 is provided as a first implicit step. The electronic unit 110 is then connected to the sensor 120 via the sensor connection 111, and a measurement value M is loaded. Next, the file with the measurement value name MB is loaded. The measurement value M and the measurement value name MB are then displayed on the first display unit 114. The user ultimately assigns the measurement value name MB or—if several measurement value names MB have been loaded by the file—one of the measurement value names MB to the measurement value M.

According to one embodiment, in the step of assigning a measurement value name, the computation unit 130 suggests the measurement value name as a function of a measurement value range to which the received measurement value can be assigned. If, for example, a measurement value M from a pH sensor is processed by the computation unit 130, and the measurement value M is in a pH range between 6 and 8 and has a temperature between 5° C. and 10° C., the measurement value M is assigned the measurement value name “Inlet basin Clarification plant 1.” However, if the measurement value M is in a pH range between 3 and 9 and has a temperature between 15° C. and 20° C., the measurement value M is assigned the measurement value name “Outlet basin Clarification plant 1”.

According to one embodiment, the electronic unit 110 further has a time unit 117 which provides the current time. In this embodiment, in the step of receiving the measurement value M from the sensor 120, the electronic unit 110 additionally stores the time of receiving the measurement value M as well as the assignment of the measurement value name MB to the measurement value M made later by the user via the first input unit 115 as a selection history in the first data memory 112. If a further measurement value M is later received from the sensor 120, the electronic unit 110 suggests a measurement value name MB based on the current time and the selection history, or automatically assigns it to the further measurement value M. This case is particularly advantageous if a user makes measurements with the electronic unit 110 and the sensor 120 at regular and constant points in time. If, therefore, different points of measurement are visited by the user in a constant order and/or at a similar time of day, the selection history enables an efficient measurement value name MB assignment.

In all embodiments, the step of receiving the at least one measurement value M from the sensor 120 may be triggered by a user input at the first input unit 115. For example, the user can thus intentionally carry out a measurement and send it directly to the electronic unit 110.

1. An electronic unit, including:
a sensor connection for receiving at least one measurement value from a sensor;
a first data memory;
a first communication module;
a first display unit; and
a first input unit;
wherein the first data memory has a file with at least one measurement value name and allows for saving the measurement value;
wherein the first display unit allows for displaying the measurement value name of the file and of the measurement value;
wherein the first input unit allows for assigning the measurement value name to the measurement value.

2. The electronic unit of claim 1, wherein:
the electronic unit further includes a time unit which provides the current time;
the electronic unit being suitable for storing a time at which the measurement value is received and the assignment, made by the user via the first input unit, of the measurement value name to the measurement value as a selection history in the first data memory; and
the electronic unit being suitable for suggesting a measurement value name based on the current time and the selection history or automatically assigning it to the further measurement value when a further measurement value is received.

3. The electronic unit of claim 1, further including:
a positioning unit suitable for generating or receiving measurement value specific positioning data; and
the electronic unit being suitable for automatically assigning the at least one measurement value name to the at least one measurement value as a function of the measurement value specific positioning data.

4. The electronic unit of claim 1, wherein the electronic unit being suitable for suggesting a
measurement value name or automatically assigning it to the measurement value as a function of a measurement value range to which the received measurement value can be assigned.

5. The electronic unit of claim 1, further:
having a sensor connection for receiving at least one measurement value from a sensor, a first data memory, a first communication module and a positioning unit;
wherein the first data memory has a file with at least one measurement value name and allows for saving the measurement value;
wherein the positioning unit is suitable for generating or receiving measurement value specific positioning data;
wherein the electronic unit is suitable for automatically assigning the at least one measurement value name to the at least one measurement value as a function of the measurement value specific positioning data.

6. A measurement value processing system, including:
an electronic unit, including a sensor connection for receiving at least one measurement value from a sensor; a first data memory; a first communication module; a first display unit; and
a first input unit; wherein the first data memory has a file with at least one measurement value name and allows for saving the measurement value; wherein the first display unit allows for displaying the measurement value name of the file and of the measurement value; wherein the first input unit allows for assigning the measurement value name to the measurement value; and
a computation unit having a second communication module and a second input unit, wherein the second input unit enables an input of at least one measurement value name, wherein the second communication module enables the transmission of the measurement value name to the electronic unit.

7. The measurement value processing system of claim 6, the computation unit comprising a
positioning unit which is suitable for providing the computation unit with measurement value specific positioning data;
wherein the computation unit is suitable for transmitting the measurement value specific positioning data to the electronic unit via the second communication module so that the electronic unit is suitable for automatically assigning the at least one measurement value name to the at least one measurement value as a function of the measurement value specific positioning data.

8. The measurement value processing system of claim 7, wherein the positioning unit is suitable for interacting with a global positioning system based on GPS, Galileo, GLONASS, BeiDou or with a local positioning system based on Bluetooth beacon, radio beacons, or LIDAR.

9. A measurement value processing method, including steps of:
providing an electronic unit, the electronic unit including a sensor connection for receiving at least one measurement value from a sensor; a first data memory; a first communication module; a first display unit; and a first input unit; wherein the first data memory has a file with at least one measurement value name and allows for saving the measurement value; wherein the first display unit allows for displaying the measurement value name of the file and of the measurement value; wherein the first input unit allows for assigning the measurement value name to the measurement value;
connecting the sensor connection of the electronic unit to a sensor;
receiving at least one measurement value from the sensor at the electronic unit;
storing the measurement value in the first data memory;
loading the file with at least one measurement value name from the first data memory;
displaying the measurement value and the at least one measurement value name; and
assigning the measurement value name to the measurement value by means of the first input unit.

10. The measurement value processing method of claim 9, the electronic unit further comprising a time unit which provides the current time;
the electronic unit being suitable for storing a time at which the measurement value is received and the assignment, made by the user via the first input unit, of the measurement value name to the measurement value as a selection history in the first data memory;
the electronic unit suggesting a measurement value name based on the current time and the selection history or automatically assigning it to the further measurement value when a further measurement value is received.

11. The measurement value processing method of claim 9, the electronic unit further comprising a positioning unit which generates or receives measurement value specific positioning data;
the electronic unit suggesting or automatically assigning the at least one measurement value name to the at least one measurement value as a function of the measurement value specific positioning data.

12. The measurement value processing method of claim 9, the electronic unit suggesting a measurement value name using a measurement value range file or automatically assigning said measurement value name to the measurement value as a function of a measurement value range to which the received measurement value can be assigned.

13. The measurement value processing method of claim 9 comprising the steps of:
having a sensor connection for receiving at least one measurement value from a sensor, a first data memory, a first communication module and a positioning unit;
wherein the first data memory has a file with at least one measurement value name and allows for saving the measurement value;
wherein the positioning unit is suitable for generating or receiving measurement value specific positioning data;
wherein the electronic unit is suitable for automatically assigning the at least one measurement value name to the at least one measurement value as a function of the measurement value specific positioning data;
connecting the sensor connection of the electronic unit to a sensor;
receiving at least one measurement value from the sensor at the electronic unit;
storing the measurement value in the first data memory;
generating or receiving measurement value specific positioning data by the positioning unit;
loading the file with at least one measurement value name from the first data memory; and
automatically assigning the measurement value name to the measurement value as a function of the measurement value specific positioning data.

14. The measurement value processing method of claim 9 comprising the steps of:
providing a measurement value processing system including an electronic unit, including a sensor connection for receiving at least one measurement value from a sensor; a first data memory; a first communication module; a first display unit; and a first input unit; wherein the first data memory has a file with at least one measurement value name and allows for saving the measurement value; wherein the first display unit allows for displaying the measurement value name of the file and of the measurement value; wherein the first input unit allows for assigning the measurement value name to the measurement value; and a computation unit having a second communication module and a second input unit, wherein the second input unit enables an input of at least one measurement value name, wherein the second communication module enables the transmission of the measurement value name to the electronic unit;
connecting the sensor connection of the electronic unit to a sensor;
receiving at least one measurement value from the sensor at the electronic unit;
storing the measurement value in the first data memory;
entering at least one measurement value name at the second input unit of the computing unit;
transmitting the measurement value name via the second communication module of the computing unit to the electronic unit;
displaying the measurement value and the at least one measurement value name; and
assigning the measurement value name to the measurement value by means of the first input unit.
